(19) United States
(12) Patent Application Publication
(10) Pub. No.: US 2017/0142739 A1
(43) Pub. Date: May 18, 2017

(54) SCHEDULING METHOD AND SCHEDULING CONTROLLER FOR WIRELESS-CONNECTED APPARATUS

(71) Applicants: YIWEI FANG, Gerrards Cross (GB); Sunil Keshavji, Ashford Middlesex (GB)

(72) Inventors: YIWEI FANG, Gerrards Cross (GB); Sunil Keshavji, Ashford Middlesex (GB)

(21) Appl. No.: 15/312,592

(22) PCT Filed: Nov. 17, 2014
(86) PCT No.: PCT/EP2014/074784

§ 371 Date: Nov. 18, 2016

(30) Foreign Application Priority Data
Jun. 17, 2014 (EP) 14172704.0

(51) Int. Cl. H04W 72/12; H04W 4/22; H04W 4/00

(52) U.S. Cl. CPC H04W 72/12; H04W 4/005; H04W 4/22

(57) ABSTRACT

A scheduling method for controlling wireless transmission of electrical data signals by an apparatus deployed within a predefined area, the method comprising controlling transmission of the data signal according to a preset policy such that, while a human belonging to a specific predetermined category is present within the predefined area, transmission of the data signal is suspended unless urgent. Human exposure to EMF emitted by the apparatus can thereby be reduced. One example implementation minimizes human exposure to EMF emission from the operation of machine-to-machine (M2M) devices in smart buildings, by reducing radio transmission of the M2M devices upon detection of a human nearby. A location-based scheduling policy can also be set for parts of the building. The scheduling policy can further be made to prioritize the EMF reduction for certain people, subject to select criteria, such as health condition, past EMF exposure, or aggregated EMF dosage.

The present invention relates to a scheduling method and scheduling controller for wirelessly-connected apparatus.

Human exposure to electromagnetic fields is not a new phenomenon, however from the 20th century environmental exposure to man-made electromagnetic fields (EMF) has steadily increased as growing electricity demand, ever-advancing technologies and changes in social behaviour have created more and more artificial sources. Everyone is exposed to a complex mix of weak electric and magnetic fields, both at home and at work, from the generation and transmission of electricity, domestic appliances and industrial equipment, to telecommunications and broadcasting.

It is not disputed that electromagnetic fields above certain levels can trigger biological effects. Experiments with healthy volunteers indicate that short-term exposure at the levels present in the environment or in the home do not cause any apparent detrimental effects. Exposures to higher levels that might be harmful are restricted by national and international guidelines. The current debate is centred on whether long-term low level exposure can evoke biological responses and influence people's wellbeing.

The long-term effect of mobile (cellular) telephone use on human health is another topic of much current research. No obvious adverse effect of exposure to low level radio frequency (RF) fields has been discovered. However, given public concerns regarding the safety of cellular telephones, further research aims to determine whether any less obvious effects might occur at very low exposure levels.

In addition to mobile telephones, apparatuses using wireless communication include, but are not limited to, M2M devices. M2M is the networking of intelligent, communications enabled, remote assets. M2M devices gather and exchange information automatically without human interaction and connect the physical world to back-end IT infrastructure. M2M-connected assets can be fixed or mobile and include cars and truck fleets, utility meters, copiers and printers, kiosks and wireless displays, ventilation and air-conditioning sensors, home medical devices, fitness monitors, and CCTV cameras.

M2M-connected devices can report on a huge range of conditions including temperature, location, consumption, heart rate, stress levels, light, acceleration, altitude, and speed. Using all this data, it is possible to obtain immediate feedback on how a particular remote asset is being used, which product features are most popular with customers, and what problems (such as errors or breakdowns) typically arise. This information is useful for improving business processes, which can help to provide a competitive edge.

An M2M solution includes intelligent sensors and microprocessors that are embedded in a remote asset, and a communications module that receives and transmits data to central management systems where it can be analysed and acted on. Often an M2M-connected endpoint will send and receive its data over wireless networks. Current networks are, for example, GSM, GPRS, EDGE, 3G, LTE, or Wi-Fi and WiMAX, however other wireless networks may be used, now or in future.

EMF exposure from M2M communication could be particularly acute, as a significant proportion of M2M devices are to be deployed in close proximity to humans, for their designed purpose of assisting people's daily life, activity and productivity. In particular, M2M devices will unavoidably become an essential part of smart buildings. At the most fundamental level, smart buildings will deliver useful building services that make occupants productive (e.g. illumination, thermal comfort, air quality, physical security, sanitation, and many more) at the lowest cost and environmental impact over the building lifecycle. Achieving this vision requires adding intelligence from the beginning of the design phase through to the end of the building's useful life. Smart buildings use information technology during operation to connect a variety of subsystems, which typically operate independently, so that these systems can share information to optimize total building performance. Smart buildings look beyond the building equipment within their four walls. They are connected and responsive to the smart power grid, and they interact with building operators and occupants to empower them with new levels of visibility and actionable information.

The forecast is that by the year 2020 there will be 50 billion M2M devices connected globally. Based on the potential effect of EMF on the health of humans, and the public concerns towards EMF exposure, it is becoming increasingly important to try to reduce the EMF footprint of wirelessly-connected devices.

Due to the significant portion of a day a human typically stays inside a building, and the enormous number of M2M devices likely to be installed around these buildings, it is particularly desirable to reduce and avoid human exposure to the EMF resulting from M2M devices, as well as other wirelessly-transmitting devices, particularly while humans are inside an EMF intensive smart building.

More generally, it is desirable to reduce the exposure to EMF of a human in a particular location which results from wireless transmission by apparatus at that location.

According to an embodiment of a first aspect of the present invention there is provided a scheduling method for controlling wireless transmission of an electrical data signal by an apparatus deployed within a predefined area, comprising controlling transmission of the data signal according to a preset policy such that, while a human belonging to a specific predetermined category is present within the predefined area, transmission of the data signal is suspended unless transmission of the data signal is, or becomes, urgent.

By controlling wireless transmission by an apparatus according to a scheduling method embodying the present invention, human exposure to EMF emitted by the apparatus can be reduced, since transmission is suspended while a human or particular human is within the predefined area unless the transmission is, or becomes, of an urgent nature.

According to an embodiment of a second aspect of the present invention there is provided a scheduling controller for controlling wireless transmission of an electrical data signal by an apparatus deployed within a predefined area, which controller is configured to control transmission of the data signal according to a preset policy such that, while a human belonging to a specific predetermined category is present within the predefined area, transmission of the data signal is suspended unless it is urgent.

A method embodying the present invention may further comprise controlling, according to the or a different preset policy, the transmission of an electrical data signal from at least one additional apparatus, also deployed within the predefined area, such that, while a human belonging to the or a different predetermined category is present within the predefined area, transmission of the data signal from the additional apparatus is also suspended unless it is urgent.

A controller embodying the present invention may be further configured to control, according to the or a different preset policy, the transmission of an electrical data signal from at least one additional apparatus, also deployed within the predefined area, such that, while a human belonging to the or a different predetermined category is present within the predefined area, transmission of the data signal from the additional apparatus is also suspended unless it is, or becomes, urgent.

Transmission of data signals is controlled according to a preset policy which, amongst other things, may specify a preset time period for which transmission of a signal is to be suspended. The policy may take account, for example, of one or more of: the type of data to be transmitted, the proximity of the apparatus to humans, the location of the apparatus (e.g. inside or outside a building, type and/or size of building), the typical occupancy of a building at different times of day and/or different times of the year, and the difference in susceptibility to EMF exposure of different humans. Each apparatus within the predefined area may be controlled according to the same preset policy or one or more of the apparatuses may be controlled according to a preset policy which is different from that of another apparatus.

There may be one predetermined category to which all humans belong, in which case non-urgent transmission is suspended if any human is present in the vicinity. Alternatively, there may be a plurality of predetermined categories, where all humans belong to one of the categories, and one or more humans also belong to at least one other predetermined category, for example a category for people with certain health conditions, a category for potentially more vulnerable (e.g. young or old) people, a category for people with a recent history of high EMF exposure, a category for people with a daily EMF exposure level aggregated from multiple locations, etc.

When the apparatus, and/or any additional apparatus, are configured to transmit at least two different types of electrical data signal, each type of electrical data signal may be ranked according to priority. Transmission of a data signal by the or each apparatus may be controlled in dependence upon the ranking of the data signal. For example, some data may not be classified as urgent, in the sense that the data must be sent whether or not a human is present, but are nevertheless time-sensitive, or some data may be considered to be more important than other data.

The predefined area may be a building, or a part of a building (such as a particular room, section or floor), or a monitored zone around the or each apparatus.

Although the apparatus, and/or the at least one additional apparatus, may desirably comprise a machine-to-machine (M2M) device, the invention may be applied to any other device which wirelessly transmits data and is located in an environment where humans may be present.

According to an embodiment of a third aspect of the present invention there is provided a system comprising at least one apparatus, configured to wirelessly transmit electrical data signals within a predefined area in which the apparatus is deployed, and a scheduling controller for controlling wireless transmission of the electrical data signals by the apparatus, wherein the scheduling controller is a scheduling controller embodying the second aspect of the present invention.

According to an embodiment of a fourth aspect of the present invention there is provided a computer program which, when run on a computer, causes that computer to carry out a method embodying the first aspect of the present invention, or to become a controller embodying the second aspect of the present invention, or to become part of a system embodying the third aspect of the present invention.

Reference will now be made, by way of example, to the accompanying drawings, in which:

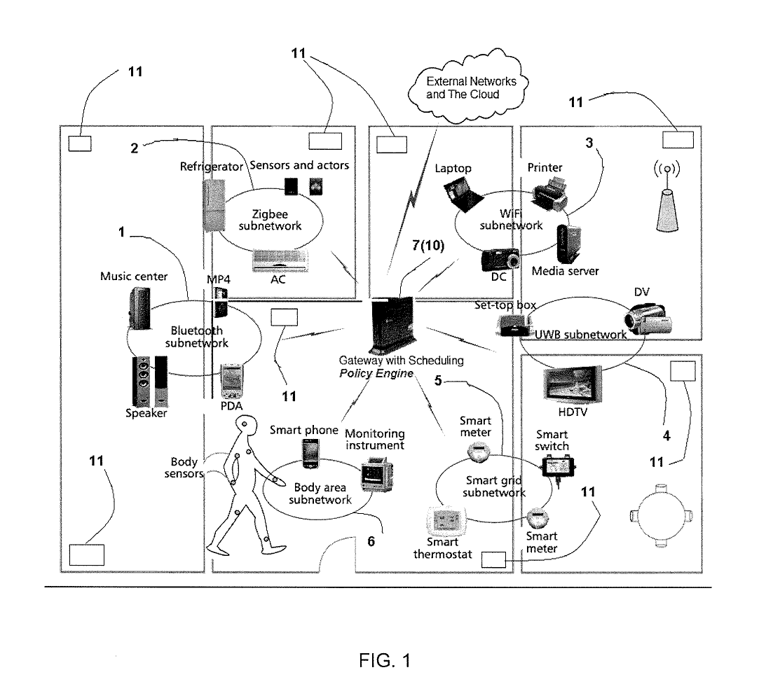

FIG. 1 is a diagram illustrating a system embodying the present invention including multiple M2M devices which can be controlled by a scheduling controller according to the second aspect of the present invention; and

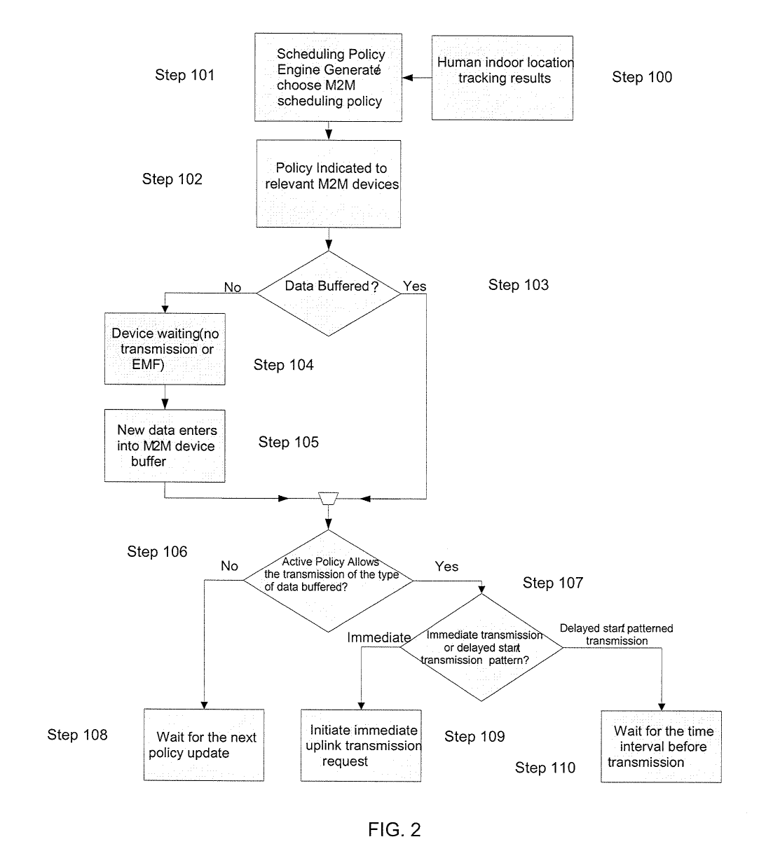

FIG. 2 is a flowchart illustrating a scheduling method embodying the first aspect of the present invention.

A scheduling controller comprising a scheduling policy engine embodying the present invention will now be described with reference to an embodiment which aims to minimize human exposure to EMF emission from M2M operation in smart buildings. The scheduling method is designed to actively reduce radio transmission of the M2M devices in a smart building, upon detection of a human in a close proximity to these devices. After detection of a human leaving a monitored zone, the scheduling controller then informs the devices to resume their transmission, clearing data in the buffer. A location-based scheduling policy can be made for various parts of the building. The scheduling policy can also be made to prioritize the EMF reduction for certain people, subject to a number of criteria, such as their health condition, past EMF exposure, or their EMF dosage information aggregated from multiple smart buildings.

It is expected that smart buildings will have the capability of being aware of human occupancy inside the building, such as whether there are people inside the building, or how many are located in which parts of the building. Furthermore, M2M traffic does not always have the urgency of real time transmission, but instead can have a relatively large delay tolerance, with the exception of emergency and disaster monitoring and reporting. These two factors combined, i.e. the knowledge of the location of people within a smart building, and the flexibility of scheduling M2M traffic, provide an opportunity for scheduling M2M radio transmissions according to the human occupancy and location information within a smart building.

FIG. 1 illustrates an architecture of M2M systems in a smart building with a scheduling controller 10 embodying the present invention. As shown in FIG. 1, there are a large number of various wireless devices installed in a smart environment, which include: in-home entertainment systems 1 using Bluetooth™, such as a wireless music centre, speakers and PDA; utility electrical equipment 2 such as a refrigerator and air conditioning system equipped with sensors and a ZigBee™ wireless communication module; WiFi sub-networks 3 such as a laptop, printer, digital camera and wireless media server; a UWB sub-network 4 such as the TV and TV set-top box; a smart grid sub-network 5 such as a smart meter, smart thermostat and smart switch; and devices in a body area network 6, which include health monitoring instruments and personal communication devices such as smart phones.

In this embodiment the proposed scheduling controller 10 (scheduling policy engine) is located within a gateway device 7, which serves as a central controlling point and is connected to the aforementioned devices 1 to 6, either via wired connections or wireless routes. If connected wirelessly, the expected wireless activity for information exchange is low, as only limited information regarding the scheduling decisions is transmitted via this link. The added EMF impact due to the operation of the scheduling policy engine is therefore expected to be negligible.

The scheduling controller 10 is configured to control transmission of electrical data signals by the devices 1 to 6. Transmission is controlled according to policies preset for each of the devices 1 to 6 such that, while a human belonging to a specific predetermined category is present within the predefined area, transmission of the data signal is suspended unless it is, or becomes, urgent.

It is expected that the presence and location of humans within a smart building could be achieved via a tracking system 11, for example employing one or more of: infrared (IR) systems; radio frequency (RF) based systems; and ultrasound based systems. The following is a brief analysis of the advantage and disadvantage of each of these systems.

A. Infrared (IR) Systems

The advantage of using an IR system to track the location of humans is its wide availability across much hardware such as mobile phones, TV, some printers and tablets, and also for its simplicity in hardware design, low cost installation and maintenance. The disadvantage of IR is its requirement for line-of-sight wireless transmission. Several commercially developed systems are based on IR, which include for example Firefly™ (see Firefly Motion Tracking System User's guide, http://www.qesturecentral.com/firefly/Firefly UserGuide.pdf), and OPTOTRAK™ (see Northen Digital Inc., Optotrak, http://www.ndigital.com/).

B. Radio Frequency (RF) Based Systems

RF systems have longer range compared to IR systems, as well as having better capability to penetrate large in-building obstacles such as people and walls. An RF system is also better suited to identify unique people or objects in the system, with triangulation and fingerprint based techniques. A number of radio access technologies can be adopted for RF based tracking, such as UMTS, LTE, WLAN, RFID (Radio Frequency Identification), Bluetooth™, ZigBee™, UWB (Ultra Wide Band), etc.

C. Ultrasound Based Systems

Ultrasound systems benefit from low cost, but suffer from lower locating precision. Active Bat (see The Bat Ultrasonic Location System, Cambridge University Computer Laboratory, http://www.cl.cam.ac.uk/research/dtg/attarchive/bat/) and Cricket (see N. Priyantha, A. Chakraborty, and H. Balakrishnan, “The cricket location-support system”, ACM MobiCom, 2000) are examples of indoor location tracking systems using ultrasound.

An embodiment of a scheduling method embodying the present invention, which can be carried out by the scheduling controller 10, will now be described with reference to the flowchart of FIG. 2. In Step 100 the human location tracking system 11 sends human in-building distribution information regarding the location of people and their distance to the EMF-emitting M2M devices 1 to 6 to the scheduling controller 10. Upon receiving such human in-building distribution information, and taking into account the building's historical occupancy information, in Step 101 the scheduling controller 10 establishes an EMF emission policy for each part of the building, such as individual rooms (alternatively, or in addition, policies could be tailored to each device individually). The policy established by the scheduling controller 10 commonly includes which type of transmission is allowed in an area. For example, in a room full of people who are having a meeting, only time critical information in addition to emergency requests might be allowed during the meeting, and transmission of the remainder of the monitoring data generated by the devices 1 to 6 might be suppressed until a later time. Then, once the meeting has finished and people have left the room, transmission of buffered non-urgent data can be resumed. For clarity, in the above discussion data has been considered to be either delay critical or non-delay critical, but in practice more priority levels regarding the traffic will also be possible and permissible. Table 1 describes an example of a policy having such multiple priority levels, as well as the corresponding action lists towards these priorities.

TABLE 1

| Data Type | The Policy - Action List |
|---|---|
| 1) - most urgent and non-delay | Transmit regardless of nearby |
| tolerant data | human(s) |
| 2) - can wait but transmit within a | Set up a short observation period, |
| specific time, high information | and transmit as long as human is not |
| integrity requirement | in direct proximity. If the observation |
| | period expires, transmitted |
| | regardless of human distance to the |
| | devices |
| 3) - can wait for a long period, low | Long observation period, only start |
| information integrity requirement | transmission if no human is near. If |
| | the observation period expires, only |
| | a specific amount of this type of |
| | buffered data is allowed for |
| | transmission. |
| 4) - only needs to be transmitted | Only transmit when no human is |
| whenever the network is free, | close to the devices or inside the |
| highly delay tolerant | buildings (such as evenings for an |
| | office) |

In Step 102 the established policies are transmitted to the devices, with limited expected wireless resources consumption. In Step 103, upon receiving a new/updated policy, each M2M device 1 to 6 checks if any buffered data is waiting to be transmitted. If no, the device 1 to 6 simply waits (Step 104) until a data transmission request arrives (Step 105). If yes, in Step 106 the device 1 to 6 then checks the data type against the current policy. If the current policy allows the buffered data to be transmitted, in Step 107 the device considers whether the current policy allows immediate transmission of that data type or whether transmission is to be delayed. If immediate transmission is allowed, in Step 109 uplink access is initiated by the device 1 to 6. Otherwise, in Step 110, transmission is delayed by a certain time interval, or a certain transmission pattern can be implemented such as “allowed for 1 kB per 10 minutes until further instruction”. If in Step 106 it is determined that the buffered data type is still banned from transmission by the policy, then in Step 108 the data is kept in the buffer to wait for the next policy update.

Various scenarios in which embodiments of the invention can be implemented will now be described. In general, unless otherwise indicated, the scenarios described below relate to scheduling M2M transmission in a smart building environment. In the aforesaid smart building, there are typically a large number of M2M devices installed around the building to provide the building users with various services or assistance. These commonly wirelessly connected M2M devices are responsible for a considerable amount of indoor EMF emission, which is a potential threat to human wellbeing.

In a first scenario, a scheduling controller embodying the present invention receives information from a human location tracking system using various human location tracking sensors and, upon detection of the presence of one or humans in close proximity to an M2M device, the controller causes the M2M device to reduce its level of RF transmission, in order to reduce its EMF impact on the human body. When it is detected that humans have moved away from the M2M device, the controller causes the device to resume transmission and clear any previously-buffered data which has accumulated in the low activity period.

A second scenario is like the first scenario, except that in addition the human location tracking system is capable of identifying individual humans, so the controller can acquire information not only on the location of humans but also on who the humans are. This allows the controller to prioritise EMF reduction for one or more particular groups of people, such as those with special requirements, disabilities or chronic health problems.

A third scenario is like the second scenario, except that in addition, when the tracking system identifies individual building users, the EMF exposure of one or more of the individuals in a pre-defined previous period, such as the previous day or the previous week, in the same smart building is also sent to the scheduling controller, in order to allow the prioritising of certain individuals for EMF reduction, such as for those that have already been exposed to more than a certain amount of EMF in the previous period.

A fourth scenario is like the third scenario, except that in addition an individual's EMF exposure record in a smart building is uploaded to a cloud server, and EMF exposure information of that person from other smart buildings that the person has recently been inside has also been uploaded to the cloud server. This allows the individual's EMF exposure information across a number of smart buildings, which has been accumulated in the cloud, to be distributed to the scheduling controllers of those buildings, which allows the scheduling controllers to make scheduling decisions accordingly.

As described above, a scheduling method and scheduling controller are proposed in order to actively reduce human exposure to EMF emitted from wirelessly transmitting devices, especially but not exclusively M2M devices installed in smart buildings. Embodiments of the invention can utilize information regarding the location of humans inside a smart building or other space to reduce or stop RF transmission of data when people, for example especially those more vulnerable individuals, are in close proximity to EMF sources. Use of the present invention could assist in alleviating public fear of the prospect of EMF exposure when there is large scale M2M deployment in the near future, provide protection to humans from the impact of EMF, and promote human health in an intelligent society.

Embodiments of the present invention may be implemented in hardware, or as software modules running on one or more processors, or on a combination thereof. That is, those skilled in the art will appreciate that a microprocessor or digital signal processor (DSP) may be used in practice to implement some or all of the functionality described above.

The invention may also be embodied as one or more device or apparatus programs (e.g. computer programs and computer program products) for carrying out part or all of the methods described herein. Such programs embodying the present invention may be stored on computer-readable media, or could, for example, be in the form of one or more signals. Such signals may be data signals downloadable from an Internet website, or provided on a carrier signal, or in any other form.

1. A scheduling method for controlling wireless transmission of an electrical data signal by an apparatus deployed within a predefined area, comprising controlling transmission of the data signal according to a preset policy such that, while a human belonging to a specific predetermined category is present within the predefined area, transmission of the data signal is suspended unless it is, or becomes, urgent.

2. A method as claimed claim 1, further comprising controlling, according to the or a different preset policy, the transmission of an electrical data signal from at least one additional apparatus, also deployed within the predefined area, such that, while a human belonging to the or a different predetermined category is present within the predefined area, transmission of the data signal from the additional apparatus is also suspended unless it is urgent.

3. A method as claimed in claim 1, wherein there is one predetermined category to which all humans belong.

4. A method as claimed in claim 1, wherein there is a plurality of predetermined categories, to one of which categories all humans belong, one or more humans having been additionally assigned to at least one of the other predetermined categories.

5. A method as claimed in claim 1, wherein the predetermined category is one of (i) a category for people with certain health conditions, (ii) a category for people who are potentially more vulnerable to EMF exposure, (iii) a category for people with a recent history of EMF exposure exceeding a certain amount, and (iv) a category for people with a daily EMF exposure level aggregated from multiple locations.

6. A method as claimed in claim 1, when the apparatus, and/or the at least one additional apparatus, is/are configured to transmit at least two different types of electrical data signal, wherein each type of electrical data signal is ranked according to priority, and transmission of a data signal by the or each apparatus is controlled in dependence upon the ranking of the data signal.

7. A method as claimed in claim 1, wherein the predefined area is a building, or a part of a building, or a monitored zone around the or each apparatus.

8. A method as claimed in claim 1, wherein the apparatus, and/or the at least one additional apparatus, comprises a machine-to-machine (M2M) device.

9. A method as claimed in claim 1, wherein the transmission of the data signal from the apparatus is suspended for a preset period.

10. A method as claimed in claim 9, wherein the preset period is determined in accordance with the extent to which the type of data to be transmitted is tolerant of delay in transmission.

11. A scheduling controller for controlling wireless transmission of an electrical data signal by an apparatus deployed within a predefined area, which controller is configured to control transmission of the data signal according to a preset policy such that, while a human belonging to a specific predetermined category is present within the predefined area, transmission of the data signal is suspended unless it is urgent.

12. A controller as claimed in claim 11, further configured to control, according to the or a different preset policy, the transmission of an electrical data signal from at least one additional apparatus, also deployed within the predefined area, such that, while a human belonging to the or a different predetermined category is present within the predefined area, transmission of the data signal from the additional apparatus is also suspended unless it is, or becomes, urgent.

13. A controller as claimed in claim 11, wherein there is one predetermined category to which all humans belong.

14. A controller as claimed in claim 11, wherein there is a plurality of predetermined categories, to one of which categories all humans belong, one or more humans having been additionally assigned to at least one of the other predetermined categories.

15. A controller as claimed in claim 11, operable, when the apparatus, and/or the at least one additional apparatus, is/are configured to transmit at least two different types of electrical data signal, and each type of electrical data signal is ranked according to priority, to control transmission of a data signal by the or each apparatus in dependence upon the ranking of the data signal.

16. A controller as claimed in claim 11, wherein the predefined area is a building, or a part of a building, or a monitored zone around the or each apparatus.

17. A controller as claimed in claim 11, wherein the apparatus, and/or the at least one additional apparatus, comprises a machine-to-machine (M2M) device.

18. A controller as claimed in claim 11, operable such that the transmission of the data signal from the apparatus is suspended for a preset period.

19. A system comprising at least one apparatus, configured to wirelessly transmit electrical data signals within a predefined area in which the apparatus is deployed, and a scheduling controller for controlling wireless transmission of the electrical data signals by the apparatus, wherein the scheduling controller is a scheduling controller as claimed in claim 11.
